(19) United States
(12) Patent Application Publication
(10) Pub. No.: US 2017/0026677 A1
(43) Pub. Date: Jan. 26, 2017

(54) DISPLAY APPARATUS AND DISPLAY METHOD

(71) Applicant: SAMSUNG ELECTRONICS CO., LTD., Suwon-si (KR)

(72) Inventors: Back-ki KIM, Suwon-si (KR); Young-ju LEE, Asan-si (KR)

(21) Appl. No.: 15/205,151

(22) Filed: Jul. 8, 2016

(30) Foreign Application Priority Data
Jul. 22, 2015 (KR) 10-2015-0103880

(51) Int. Cl. H04N 21/254; H04N 21/81; H04N 21/4627; H04N 21/61; G06F 3/0482; G06F 3/0488

(52) U.S. Cl. CPC H04N 21/2541; G06F 3/0482; G06F 3/04883; H04N 21/4627; H04N 21/6125; H04N 21/8166

(57) ABSTRACT

A display apparatus and a display method are provided. The display apparatus includes a display configured to display a user interface including at least one item corresponding to at least one application, wherein, based on an input for selecting the item, an application corresponding to the selected item is executed; and a controller configured to remove digital rights management (DRM) of the at least one application corresponding the at least one item before the input for selecting one of the at least one displayed item is received.

### CROSS-REFERENCE TO RELATED APPLICATION

This application is based on and claims priority under 35 U.S.C. §119 to Korean Patent Application No. 10-2015-0103880, filed on Jul. 22, 2015, in the Korean Intellectual Property Office, the disclosure of which is incorporated by reference herein in its entirety.

### BACKGROUND

1. Field

The present disclosure relates to a display apparatus and a display method, and for example, to a display apparatus and a display method with improved efficiency for removing digital rights management (DRM) of an application.

2. Description of Related Art

A display apparatus is an apparatus capable of displaying an image that may be viewed by a user. A user may watch a broadcast via a display apparatus. A display apparatus displays a broadcast selected by a user from among broadcasts transmitted by broadcasting stations. Currently, broadcasting is being switched from analog broadcasting to digital broadcasting worldwide.

A digital broadcasting service refers to a broadcasting service that transmits digital images and digital voice signals. Since a digital broadcasting service is more resistant to external noise than an analog broadcasting service, a digital broadcasting service exhibits less data loss, easier error correction, high resolution, and clear images. Also, unlike an analog broadcasting service, a digital broadcasting service may be a bidirectional service.

Recently, smart TV service providers provide various types of applications for providing various content demanded by users of smart TVs. Such applications may be encrypted based on digital rights management (DRM) to prevent illegal duplication of the applications and allow only authorized users to use the applications.

### SUMMARY

According to example embodiments of the present disclosure, as a display apparatus performs DRM removal before an input for executing an application is received, the display apparatus may reduce time period for waiting for DRM removal.

Furthermore, when memory spaces for removing DRM are allocated by a daemon in a display apparatus before an application is executed, a memory space may be saved as compared to a case where memory spaces for removing DRM are allocated by application processes after the application processes are executed.

Additional aspects will be set forth in part in the description which follows and, in part, will be apparent from the description.

According to an aspect of an example embodiment, a display apparatus includes a display configured to display a user interface including at least one item corresponding to at least one application, wherein, based on an input for selecting an item, an application corresponding to the selected item is executed; and a controller including processing circuitry configured to remove digital rights management (DRM) of the at least one application corresponding the at least one item before the input selecting one of the at least one displayed item is received.

In one example embodiment, the controller may be configured to execute the DRM-removed application in response to the received input.

In one example embodiment, the controller may be configured to remove DRM of at least one application corresponding to at least one item to be displayed in the user interface based on an input for turning ON the display apparatus.

In one example embodiment, the controller may be configured to remove DRM of at least one application corresponding to at least one item to be displayed in the user interface as an application that is being executed based on the input is terminated.

In one example embodiment, the controller may be configured to remove DRM of an application using a daemon.

In one example embodiment, the daemon may be configured to execute a candidate process, and the candidate process may be configured to load a DRM module for removing DRM to a memory.

In one example embodiment, the candidate process may be renamed to the process of the application based on the input.

According to an aspect of another example embodiment, a display method includes displaying a user interface including at least one item corresponding to at least one application, wherein, based on an input for selecting an item, an application corresponding to the selected item is executed; and removing digital rights management (DRM) of the at least one application corresponding the at least one item before the input for selecting one of the at least one displayed item is received.

In one example embodiment, the executing may include executing the DRM-removed application in response to the input.

In one example embodiment, the removing of the DRM may include removing DRM of at least one application corresponding to at least one item to be displayed in the user interface based on an input for turning ON a display apparatus.

In one example embodiment, the removing of the DRM may include removing DRM of at least one application corresponding to at least one item to be displayed in the user interface as an application that is being executed based on the input is terminated.

In one example embodiment, the removing of the DRM may include removing DRM of an application using a daemon.

In one example embodiment, the removing of the DRM using the daemon may include executing a candidate process via the daemon; and loading a DRM module for removing DRM to a memory via the candidate process.

In one example embodiment, the removing of the DRM using the daemon may further include renaming the candidate process to the process of the application based on the input.

According to an aspect of another example embodiment, there is provided a non-transitory computer readable recording medium having recorded thereon a computer program for implementing the display method.

### BRIEF DESCRIPTION OF THE DRAWINGS

These and/or other aspects will become apparent and more readily appreciated from the following detailed description, taken in conjunction with the accompanying drawings, in which like reference numerals refer to like elements, and wherein:

FIG. 1 is a diagram illustrating an example display apparatus according to an example embodiment;

FIG. 2 is a block diagram illustrating an example display apparatus according to an example embodiment;

FIG. 3 is a block diagram illustrating an example configuration of the display apparatus according to an example embodiment;

FIG. 4 is a flowchart illustrating an example method of operating the display apparatus, according to an example embodiment;

FIG. 5A is a diagram illustrating an example display apparatus displaying an initial screen based on an input for turning ON the display apparatus;

FIG. 5B is a diagram illustrating an example display apparatus displaying an execution screen of an application corresponding to an item;

FIG. 5C is a diagram illustrating an example display apparatus displaying an execution screen of an application corresponding to an item;

FIG. 6 is a flowchart illustrating an example method of operating the display apparatus according to another example embodiment;

FIG. 7 is a diagram illustrating an example display apparatus displaying a user interface as an application being executed is terminated;

FIG. 8 is a flowchart illustrating an example method by which the display apparatus removes DRM of an application by using a daemon;

FIGS. 9A through 9C are diagrams illustrating an example in which the display apparatus allocates a memory space for removing DRM.

### DETAILED DESCRIPTION

Reference will now be made in detail to example embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

It will be understood that although the terms first and second are used herein to describe various elements, these elements should not be limited by these terms. These terms are only used to distinguish one element from another element. Thus, a first element discussed below could be termed a second element, and similarly, a second element may be termed a first element without departing from the teachings of this disclosure.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Throughout the specification, a ‘display’ may refer to a component that visually displays image data. Furthermore, in some embodiments, when display panel included in a display and a touch pad constitute a layered structure and are configured as a touch screen, the display may be used not only as an output device, but also as an input device. The display may include at least one of a liquid crystal display (LCD), a thin-film transistor LCD, an organic light-emitting diode (OLED) display, a flexibly display, a 3D display, an electrophoretic display, and a plasma display panel (PDP).

A ‘display apparatus’ may refer, for example, to an output apparatus including the above-stated display and is an apparatus capable of visually displaying image data. A display apparatus may be connected to a desktop PC, a laptop PC, a table PC, a camera, a mobile phone, a storage medium, and any of various other electronic devices and may receive image data via a wire or wirelessly. In some embodiments, a display apparatus may receive an analog broadcast signal or a digital broadcast signal. A display apparatus may be embodied not only as a flat panel display apparatus, but also as a curved display apparatus having a curvature or a flexible display apparatus of which curvature may be adjusted. Furthermore, a display apparatus may include a PC monitor and a TV monitor and may also include a large format display (LFD). Furthermore, in some embodiments, a display apparatus may include two or more displays.

A portion of a display of a display apparatus in which content is actually output may be referred to as a screen.

Furthermore, throughout the specification, a ‘user’ may refer, for example, to a person who controls a function or an operation of a display apparatus and may include a manager or an installation engineer.

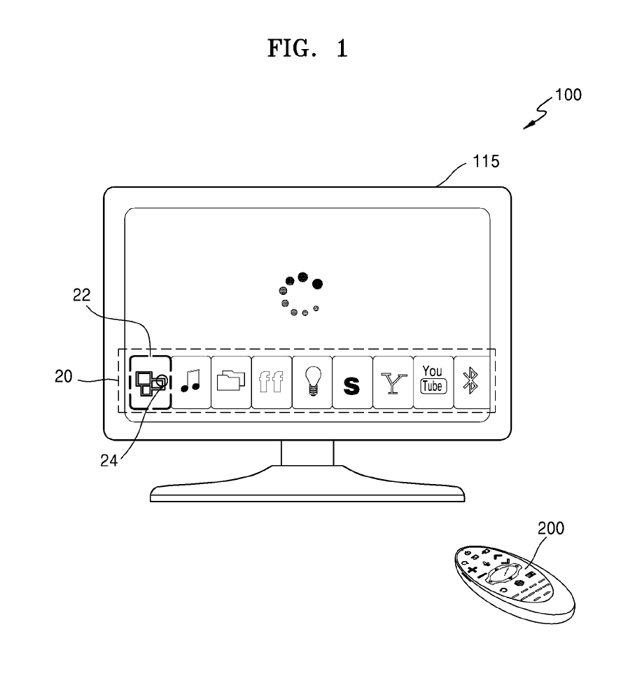

FIG. 1 is a diagram illustrating an example display apparatus 100 according to an example embodiment.

Referring to FIG. 1, the display apparatus 100 providing a plurality of applications encrypted based on digital rights management (DRM) according to an embodiment is shown.

The display apparatus 100 may provide a user interface 20 including at least one item corresponding to at least one application on a display 115.

Each item included in a user interface may correspond to at least one application.

For example, applications may include an application for providing video content (e.g., movies or dramas), an application for providing audio content (e.g., music), an application for providing broadcast channels, an application for providing history information regarding content accessed by a user, an application for providing an image showing an interface for connecting the display apparatus 100 to an external apparatus, and an application for displaying an external apparatus connected to the display apparatus 100.

An item may be displayed as an image for indicating a corresponding application. For example, an item may include a movie poster image or a drama poster image, a poster image regarding a music album, a screen image of the most recently executed application, an image showing a port of a display apparatus to be connected to an external apparatus (e.g., an image indicating a high-definition multimedia interface (HDMI) port, an image indicating a universal serial bus (USB) port, etc.), etc.

The display apparatus 100 may receive a user input for selecting an item 22 via a control apparatus 200. Referring to FIG. 1, the display apparatus 100 may receive a user input for selecting the item 22 from a plurality of items included in a user interface 20. The display apparatus 100 may execute an application corresponding to the item 22 based on the received user input. The item 22 may be displayed as an image or a moving picture related to the corresponding application or a screen image of the most recently executed application.

In one embodiment, an application may be provided by the manufacturer of the display apparatus 100. Alternatively, the application may be an application provided by an application provider, not by the manufacturer of the display apparatus 100. The application may be encrypted based on DRM rights of a user having a legitimate right to use the application.

DRM may refer, for example, to a technique for managing copyrighted digital content to prevent illegal duplication of content and allow only an authorized user to use the content. DRM may include techniques, such as PlayReady, Widevine, AES128, Verimatrix, SecureMedia, SDRM, and SCSA, but is not limited thereto.

The display apparatus 100 may execute a DRM-protected application or execute content encrypted based on DRM via an application. Hereinafter, a case where the display apparatus 100 executes a DRM-protected application will be described.

In one embodiment, the display apparatus 100 may perform license authorization and removal of DRM with regard to an application encrypted based on DRM, and then the display apparatus 100 may execute the application. Hereinafter, removal of DRM with regard to at least one application that is encrypted based on DRM will be referred to as DRM removal.

In one embodiment, the display apparatus 100 may remove DRM of an application in advance before a user input for executing the application. As the display apparatus 100 performs DRM removal before a user input for executing an application is received, the display apparatus 100 may reduce the time period for a user to wait for DRM removal.

For example, the display apparatus 100 may perform DRM removal based on an input for turning ON the display apparatus 100. In detail, the display apparatus 100 may remove DRM of applications corresponding to items that may be displayed in the user interface 20 based on an input for turning ON the display apparatus 100. In another example, the display apparatus 100 may perform DRM removal as an application being executed is terminated. In detail, the display apparatus 100 may remove DRM of applications corresponding to items that may be displayed in the user interface 20 as an application being executed is terminated.

Meanwhile, referring to FIG. 1, the display apparatus 100 may display a cursor 24 on a display screen of the display 115 in correspondence to a pointing location of the control apparatus 200. A user may locate the cursor 24 on an item 22 by moving the control apparatus 200. The user may select the item 22 by using the control apparatus 200. For example, the user may select the item 22 by pressing a key on the control apparatus 200 or touching a touch pad. Based on an input of the user for selecting the item 22, the display apparatus 100 may execute an application corresponding to the item 22. The display apparatus 100 may execute a DRM-removed application based on the input of the user for selecting the item 22.

The display apparatus 100 may require up to 1 second or 2 seconds, for example, to perform DRM removal. In one embodiment, as the display apparatus 100 performs DRM removal before a user input for executing an application is received, the display apparatus 100 may reduce the time period for a user to wait for DRM removal. As a time period for a user to wait for DRM removal is reduced, speed of the display apparatus 100 felt by the user may be improved. For example, a time period for a user to wait for DRM removal of the display apparatus 100 may be reduced by from about 0.5 seconds to about 2 seconds.

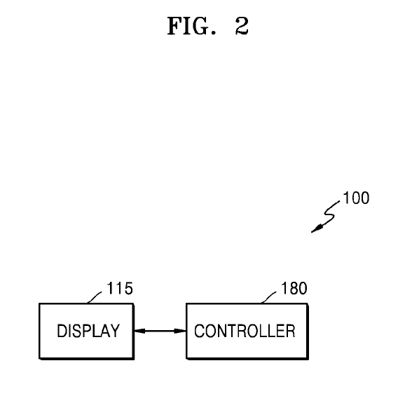

FIG. 2 is a block diagram illustrating an example display apparatus 100 according to an example embodiment.

Referring to FIG. 2, the display apparatus 100 may include the display 115 and a controller (e.g., including processing circuitry) 180.

In one embodiment, the display 115 may display a user interface including at least one item corresponding to at least one application under the control of the controller 180.

In one embodiment, the display 115 may display an execution screen image regarding an application DRM-removed based on a received input, such as, for example, a user input, under the control of the controller 180.

In one embodiment, the display 115 may display a user interface including at least one item based on an input for turning ON the display apparatus 100, under the control of the controller 180.

In one embodiment, the display 115 may display a user interface including at least one item as an application being executed is terminated, under the control of the controller 180.

In one embodiment, the controller 180 may control the display 115 to display a user interface including at least one item corresponding to at least one application.

In one embodiment, the controller 180 may execute an application corresponding to an item selected based on a user input for selecting one from at least one item. Furthermore, the controller 180 may remove DRM of at least one application before a user input is received.

In one embodiment, the controller 180 may control the display 115 to display an execution screen image regarding an application DRM-removed based on an input.

In one embodiment, the controller 180 may control the display 115 to display a user interface including at least one item based on an input for turning ON the display apparatus 100.

In one embodiment, the controller 180 may control the display 115 to display a user interface including at least one item as an application being executed is terminated.

In one embodiment, the controller 180 may execute an application DRM-removed based on an input.

In one embodiment, the controller 180 may remove DRM of an application corresponding to at least one item that may be displayed in a user interface based on an input for turning ON the display apparatus 100.

In one embodiment, the controller 180 may remove DRM of an application corresponding to at least one item that may be displayed in a user interface as an application being executed is terminated.

In one embodiment, the controller 180 may remove DRM of an application using a daemon. The daemon may be executed by the controller 180 when the display apparatus 100 is turned ON. Furthermore, the controller 180 may control the daemon to be executed in the background while an application is being executed.

In one embodiment, the controller 180 may control the daemon to execute a candidate process. In detail, the controller 180 may fork the candidate process, e.g., the controller 180 may execute the candidate process. Here, the daemon may be a parent process, whereas the candidate process may be a child process of the daemon

The controller 180 may control the candidate process to load a DRM module for removing DRM to a memory. The memory may include a RAM 181, for example. The controller 180 may control the candidate process to load the DRM module. Furthermore, the controller 180 may control the candidate process to allocate a memory space for removing DRM of an application. Furthermore, the controller 180 may control to rename the candidate process to the process of an application based on a user input. When the candidate process is renamed to the process of an application, the controller 180 may execute a DRM-removed application. Next, the controller 180 may control the display 115 to display an execution screen image of the application.

In one embodiment, when an application being executed is terminated, the controller 180 may control the daemon to re-execute the candidate process. In detail, the controller 180 may fork the candidate process again. Next, the controller 180 may control the candidate process for DRM removal.

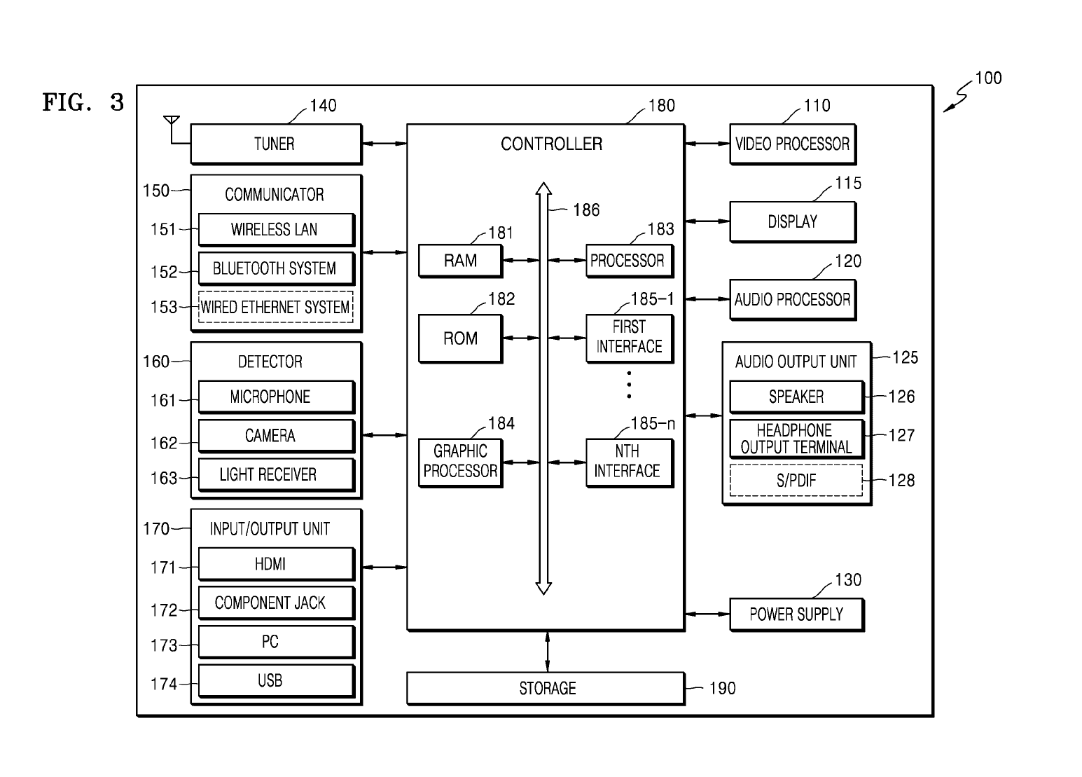

FIG. 3 is a diagram illustrating an example configuration of the display apparatus 100 according to an example embodiment.

Referring to FIG. 3, the display apparatus 100 may include, for example, a video processor 110, the display 115, an audio processor 120, an audio output unit 125, a power supply 130, a tuner 140, a communicator (e.g., including communication circuitry) 150, a detector (e.g., including various detection circuitry) 160, an input/output unit (e.g., including input/output circuitry) 170, the controller (e.g., including processing circuitry) 180, and a storage 190.

The video processor 110 processes video data received by the display apparatus 100. The video processor 110 may perform various image processing tasks with regard to video data, such as decoding, scaling, noise filtering, frame rate transformation, and resolution transformation.

The display 115 displays a video included in a broadcast signal received via the tuner 140, under the control of the controller 180. Furthermore, the display 115 may display content (e.g., a moving picture) input via the communicator 150 or the input/output unit 170, under the control of the controller 180. The display 115 may output an image stored in the storage 190, under the control of the controller 180. Furthermore, the display 115 may display a voice user interface (UI) (e.g., a UI including a voice command guide) for performing a voice recognition task or a motion UI (e.g., a UI including a user motion guide for motion recognition) for performing a motion recognition task.

In one embodiment, the display 115 may display a user interface including at least one item corresponding to at least one application, under the control of the controller 180.

Furthermore, in one embodiment, the display 115 may display an execution screen image of an application DRM-removed based on an input, under the control of the controller 180.

Furthermore, in one embodiment, the display 115 may display a user interface including at least one item based on an input for turning ON the display apparatus 100, under the control of the controller 180.

Furthermore, in one embodiment, the display 115 may include a user interface including at least one item as an application being executed is terminated.

The audio processor 120 processes audio data. The audio processor 120 may perform various audio processing tasks with regard to audio data, such as decoding, amplification, and noise filtering. Meanwhile, the audio processor 120 may include a plurality of audio processing modules for processing audios corresponding to a plurality of content.

The audio output unit 125 includes output circuitry that outputs an audio included in a broadcast signal received via the tuner 140, under the control of the controller 180. The audio output unit 125 may output an audio (e.g., a voice or a sound) input via the communicator 150 and/or the input/output unit 170, under the control of the controller 180. Furthermore, the audio output unit 125 may output an audio stored in the storage 190, under the control of the controller 180. The audio output unit 125 may include at least one of a speaker 126, a headphone output terminal 127, and a Sony/Philips digital interface (S/PDIF) output terminal 128. The audio output unit 125 may include a combination of the speaker 126, the headphone output terminal 127, and the S/PDIF output terminal 128.

The power supply 130 supplies power input from an external power source to internal components 110 through 190 of the display apparatus 100 under the control of the controller 180. Furthermore, the power supply 130 may supply power output by one, two, or more batteries (not shown) disposed in the display apparatus 100 to the internal components of the display apparatus 100 under the control of the controller 180

The tuner 140 may tune and select frequency corresponding to a channel to be received by the image display apparatus 100 among a large number of frequency ingredients in a broadcasting signal that is received via a wire or wirelessly by amplifying, mixing, and resonating the broadcasting signal. A broadcasting signal includes an audio data signal, a video signal, and additional information (e.g., electronic program guide (EPG)).

The tuner 140 may receive a broadcasting signal in a frequency band corresponding to a channel number (e.g., a cable broadcast No. 506) based on a user input (e.g., a control signal received from the control apparatus 200, such as a channel number input, a channel up-down input, and a channel input on an EPG screen image).

The tuner 140 may receive a broadcasting signal from various sources, such as a ground wave broadcasting service, a cable broadcasting service, a satellite broadcasting service, and an internet broadcasting service. The tuner 140 may receive a broadcasting signal from sources like an analog broadcasting service or a digital broadcasting service. A broadcasting signal received by the tuner 140 is decoded (e.g., audio decoding, video decoding, or additional information decoding) and is split to an audio signal, a video signal, and/or additional information. The audio signal, the video signal, and/or the additional information obtained from the broadcasting signal may be stored in the storage unit 190 under the control of the controller 180.

The display apparatus 100 may include one tuner 140 or a plurality of tuners 140. In one embodiment, when the display apparatus 100 includes the plurality of tuners 140, a plurality of broadcast signals may be output to a plurality of windows constituting a multi-window screen image provided to the display 115.

The tuner 140 may be integrated with the display apparatus 100, may be embodied as an independent device (e.g., a set-top box (not shown)) having a tuner electrically connected to the display apparatus 100, or may be embodied as a tuner connected to the input/output unit 170.

The communicator 150 may include various communication circuitry to connect the display apparatus 100 to an external device (e.g., an audio device) under the control of the controller 180. The controller 180 may transmit/receive content to/from the external device connected via the communicator 150, download an application from the external device, or browse web pages via the external device. The communicator 150 may include one or more of various communication circuitry, including, for example a wireless LAN module 151, a Bluetooth module 152, and a wire Ethernet module 153 based on performance and structure of the display apparatus 100. Furthermore, the communicator 150 may include a combination of the wireless LAN module 151, the Bluetooth module 152, and the wire Ethernet module 153. The communicator 150 may receive a control signal of the control apparatus 200 under the control of the controller 180. A control signal may be embodied as a Bluetooth signal, a RF signal, or a Wi-Fi signal.

The communicator 150 may include short-range wireless communication modules other than the Bluetooth module 152, e.g., a near field communication (NFC) module (not shown), a Bluetooth low energy (BLE) module, etc.

The detector 160 may include various circuitry to detect a voice of a user, an image of the user, or an interaction of the user.

The microphone 161 receives a voice uttered by a user. The microphone 161 may transform a received voice into an electric signal and output the electric signal to the controller 180. A user's voice may include a voice corresponding to a menu or a function of the display apparatus 100. A voice recognition range of the microphone 161 may be within a distance about 4 meters from the microphone 161, where the voice recognition range of the microphone 161 may vary based on the volume of a voice of a user and surrounding environmental conditions (e.g., a volume of a speaker, ambient noise, etc.).

The microphone 161 may be integrated with the display apparatus 100 or may be embodied as an independent device. The independent microphone 161 may be connected to the display apparatus 100 via the communicator 150 or the input/output unit 170.

It would be apparent to one of ordinary skill in the art that the microphone 161 may be omitted according to performances and structures of the display apparatus 100.

The camera 162 receives an image (e.g., successive frames) corresponding to a user's motion including a gesture within a recognition range of the camera 162. For example, the recognition range of the camera 162 may be within a distance from about 0.1 m to about 5 m from the camera 162. A user's motion may include a motion of a body part of the user, e.g., a face, a face expression, a hand, a fist, a finger, etc. The camera 162 may transform a received image into an electric signal and output the electric signal to the controller 180, under the control of the controller 180. By using a received result of motion recognition, the controller 180 may select a menu displayed on the display apparatus 100 or perform a task corresponding to the result of the motion recognition. For example, the controller 180 may adjust volume or move a cursor.

The camera 162 may include a lens (not shown) and an image sensor (not shown). The camera 162 may provide optical zoom or digital zoom by using a plurality of lenses and image processing techniques. The recognition range of the camera 162 may vary according to angles of the camera 162 and surrounding environmental conditions. If the camera 162 consists of a plurality of cameras, a 3-dimensional (3D) still image or a 3D motion may be received by using the plurality of cameras.

The camera 162 may be integrated with the display apparatus 100 or may be embodied as an independent device. An independent device (not shown) including the camera 162 may be electrically connected to the display apparatus 100 via the communicator 150 and/or the input/output unit 170.

It would be apparent to one of ordinary skill in the art that the camera 162 may be omitted according to performances and structures of the display apparatus 100.

The light receiver 163 receives an optical signal (including a control signal) from the external control apparatus 200 via an optical window (not shown) of the bezel of the display 115. The light receiver 163 may receive an optical signal corresponding to a user input (e.g., a touch, a press, a touch gesture, a voice, or a motion) from the control apparatus 200. A control signal may be extracted from the received optical signal under the control of the controller 180.

It would be apparent to one of ordinary skill in the art that the light receiver 163 may be omitted according to performances and structures of the display apparatus 100.

The input/output unit 170 may include various input/output circuitry including circuitry that receives a video (e.g., moving pictures, etc.), an audio (e.g., voice, music, etc.), and additional information (e.g., an EPG, etc.) from outside of the display apparatus 100 under the control of the controller 180. The input/output unit 170 may include at least one of a high-definition multimedia interface (HDMI) port 171, a component jack 172, a PC port 173, and a USB port 174. The input/output unit 170 may include a combination of the HDMI port 171, the component jack 172, the PC port 173, and the USB port 174. According to some embodiments, the input/output unit 170 may further include at least one of a D-sub port, a digital visual interface (DVI) port, and a DisplayPort (DP).

It would be apparent to one of ordinary skill in the art that configurations and operations of the input/output unit 170 may vary according to example embodiments of the disclosure.

The controller 180 includes processing circuitry that is configured to control the overall operations of the display apparatus 100, controls signal flows between internal components 110 through 190 of the display apparatus 100, and processes data. When a user input is applied or a certain pre-set condition is satisfied, the controller 180 may execute an operating system (OS) and various applications stored in the storage unit 190.

The controller 180 may include a RAM 181 that stores a signal or data input from outside of the display apparatus 100 or is used as a storage area corresponding to various tasks performed by the display apparatus 100, a ROM 182 having stored therein control programs for controlling the display apparatus 100, and a processor 183.

In one embodiment, the controller 180 may control the display 115 to display a user interface including at least one item corresponding to at least one application.

In one embodiment, the controller 180 may execute an application corresponding to an item selected based on a user input for selecting one of at least one item. Furthermore, the controller 180 may remove DRM of the at least one application corresponding to the at least one item included in a user interface before receiving the user input.

In one embodiment, the controller 180 may control the display 115 to display an execution screen image regarding an application DRM-removed in response to a user input.

In one embodiment, the controller 180 may control the display 115 to display a user interface including at least one item based on an input for turning ON the display apparatus 100.

In one embodiment, the controller 180 may control the display 115 to display a user interface including at least one item as an application being executed is terminated.

In one embodiment, the controller 180 may execute an application DRM-removed based on a user input.

In one embodiment, the controller 180 may remove DRM of an application corresponding to at least one item that may be displayed in a user interface based on an input for turning ON the display apparatus 100.

In one embodiment, the controller 180 may remove DRM of an application corresponding to at least one item that may be displayed in a user interface as an application being executed is terminated.

In one embodiment, the controller 180 may remove DRM of an application using a daemon. The daemon may be executed by the controller 180 when the display apparatus 100 is turned ON. Furthermore, the controller 180 may control the daemon to be executed in the background while an application is being executed.

In one embodiment, the controller 180 may control the daemon to execute a candidate process. In detail, the controller 180 may fork a candidate process. Here, the daemon may be a parent process, whereas the candidate process may be a child process of the daemon.

The controller 180 may control the candidate process to load a DRM module for removing DRM to a memory. The memory may include a RAM 181, for example. The controller 180 may control the candidate process to load the DRM module. Furthermore, the controller 180 may control the candidate process to allocate a memory space for removing DRM of an application. Furthermore, the controller 180 may control to rename the candidate process to the process of an application based on a user input. When the candidate process is renamed to the process of an application, the controller 180 may execute a DRM-removed application. Next, the controller 180 may control the display 115 to display an execution screen image of the application.

In one embodiment, when an application being executed is terminated, the controller 180 may control the daemon to re-execute the candidate process. In detail, the controller 180 may fork the candidate process again. Next, the controller 180 may control the candidate process for DRM removal.

Furthermore, the processor 183 may include a graphics processing unit (GPU) (not shown) for processing graphics data corresponding to a video. The processor 183 may be embodied as a system-on-chip (SoC) having integrated thereon a core (not shown) and a GPU (not shown). The processor 183 may include a single core, dual cores, triple cores, quad cores, and cores in multiples of 4.

Furthermore, the processor 183 may include a plurality of processors. For example, the processor 183 may include a main processor (not shown) and a sub processor (not shown) that operates in a sleep mode.

The graphic processor 184 generates a screen image including various objects, such as icons, images, and texts, by using a calculator (not shown) and a renderer (not shown). The calculator calculates property values, such as coordinates, shapes, sizes, and colors for displaying respective objects, according to layouts of screen images by using a detected user interaction. The renderer generates screen images of various layouts including objects based on property values calculated by the calculator. A screen image generated by the renderer is displays in a display area of the display 115.

First through nth interfaces 185-1 through 185-n are connected to the above-stated components. One of the first through nth interfaces 185-1 through 185-n may be a network interface that is connected to an external device via a network. The RAM 181, the ROM 182, the processor 183, the graphic processor 184, and the first through nth interfaces 185-1 through 185-n may be connected to one another via an internal bus 186.

The storage unit 190 may store various data, programs, or applications for operating and controlling the display apparatus 100 under the control of the controller 180. The storage unit 190 may store signals or data input/output in correspondence to operations of the video processor 110, the display 115, the audio processor 120, the audio output unit 125, the power supply 130, the communicator 150, the detector 160, the input/output unit 170, and the user input unit 175.

The storage 190 may store control programs for controlling the display apparatus 100 and the controller 180 and applications that are initially provided by a manufacturer or downloaded from outside. In detail, the storage 190 may store resources used by applications, such as JavaScript files and XML files.

In one embodiment, the storage 190 may store a list of applications to be DRM-removed when the display apparatus 100 is turned ON. Furthermore, the storage 190 may store a list of applications to be DRM-removed according to pre-set criteria. For example, the storage 190 may store a list of recently executed applications. Furthermore, the storage 190 may store a list of frequently executed applications. Furthermore, the storage 190 may store a list of applications provided by the manufacturer of the display apparatus 100. The storage 190 may store rules for determining whether to remove DRM according to pre-set criteria when a new application is downloaded.

The storage 190 may store an OS that is executed when the display apparatus 100 is turned ON. Furthermore, the storage 190 may store a daemon. Furthermore, the storage 190 may store a DRM removing module for removing DRM of an application. Furthermore, the storage 190 may store graphical user interfaces (GUI) related to applications, objects for providing GUIs (e.g., images, texts, icons, buttons, etc.), user information, documents, databases, or related data.

In one embodiment, the term “storage unit” includes the storage unit 190, the ROM 182 and the RAM 181 of the controller 180, and/or a memory card (not shown) attached to the display apparatus 100 (e.g., a micro SD card, a USB memory, etc.). Furthermore, the storage unit 190 may include a non-volatile memory, a volatile memory, a hard disk drive (HDD), or a solid state disk (SSD).

Although not shown, the storage unit 190 may include a volume control module, a communication control module, a voice recognition module, a motion recognition module, an optical receiving module, a display control module, an audio control module, an external input control module, a power control module, a module for controlling a wirelessly connected external device (e.g., connected via a Bluetooth communication), a voice database (DB), or a motion DB. The modules (not shown) and the DB (not shown) of the storage unit 190 may be embodied in the form of software for controlling the display apparatus 100 to perform a volume control function, a communication control function, a voice recognition function, a motion recognition function, an optical reception control function, a display control function, an audio control function, an external input control function, a power control function, or a display control function including moving a cursor or scrolling items. The controller 180 may perform the above-stated functions by using the software modules stored in the storage unit 190.

The storage 190 may include a presentation module. The presentation module is a module for configuring a screen image to be displayed. The presentation module may includes a multimedia module for reproducing and outputting multimedia content and a UI rendering module that processes UIs and graphics. The multimedia module may include a player module, a camcorder module, a sound processing module, etc. Therefore, the multimedia module reproduces various multimedia content and generates and reproduces screen images and sounds. The UI rendering module may include an image compositor module for combining images, a coordinate combining module that combines and generates on-screen coordinates for displaying an image, an X11 module that receives various events from a hardware component, and a 2D/3D UI toolkit that provides tools for configuring a 2D or 3D UI.

The display apparatus 100 may be electrically connected to an independent external device including a tuner (e.g., a set-top box) (not shown). For example, the display apparatus 100 may be embodied as an analog TV, a digital TV, a 3D TV, a smart TV, a LED TV, an OLED TV, a plasma TV, or a monitor. However, it would be apparent to one of ordinary skill in the art that the disclosure is not limited thereto.

The display apparatus 100 may include a sensor (not shown) for detecting a condition inside or outside the display apparatus 100 (e.g., an illuminance sensor, a temperature sensor, etc.).

Additional components may be introduced to the display apparatus 100 of FIG. 3 or some of the components (e.g., 110 through 190) of the display apparatus 100 shown in FIG. 3 may be omitted according to performance of the display apparatus 100. Furthermore, it would be apparent to one of ordinary skill in the art that locations of the components (e.g., the 110 through 190) may vary according to performances or structures of the display apparatus 100.

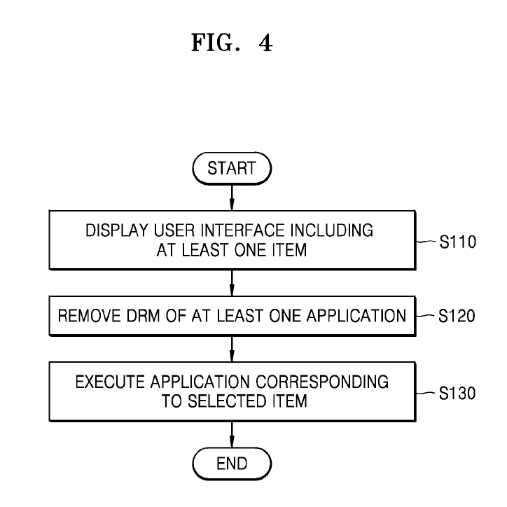

FIG. 4 is a flowchart illustrating an example method of operating the display apparatus 100, according to an example embodiment.

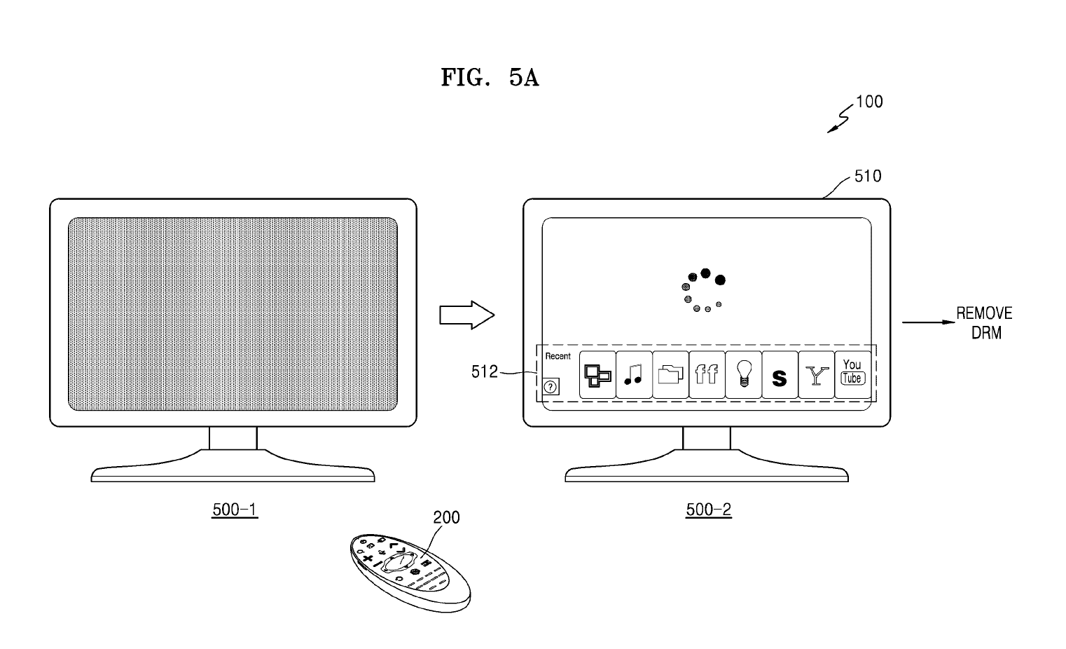

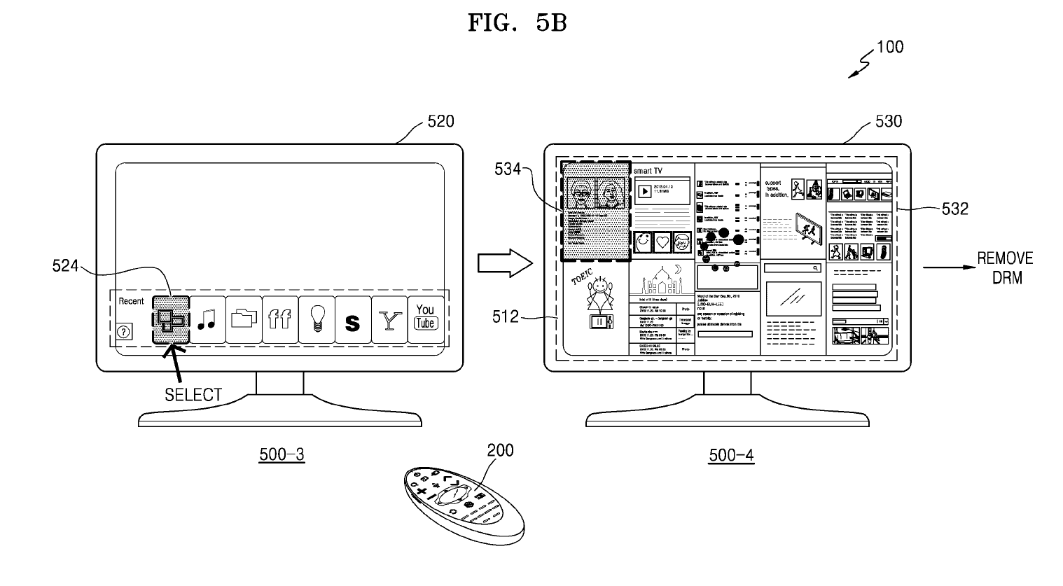

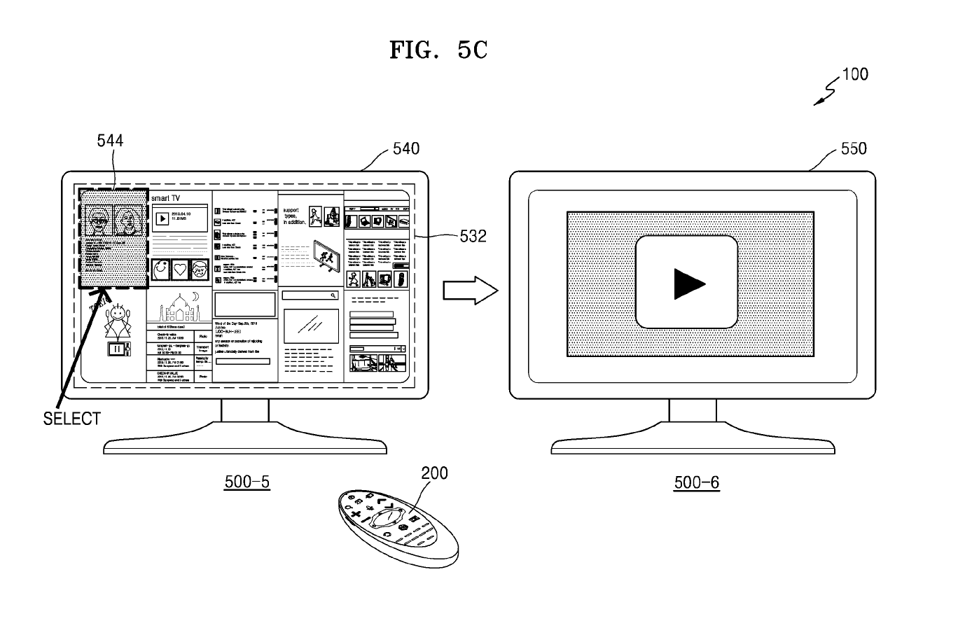

Hereinafter, the flowchart illustrated in FIG. 4 will be described in relation to the display apparatus 100 illustrated in FIGS. 5A through 5C.

In operation S110, the display apparatus 100 may display a user interface including at least one item corresponding to at least one application (operation S110). The user interface including at least one item may be displayed at any time point during an operation of the display apparatus 100.

In one embodiment, the display apparatus 100 may provide a user interface including at least one item in a screen image that is displayed on the display apparatus 100 as the display apparatus 100 is turned ON.

In one embodiment, the display apparatus 100 may provide a user interface including at least one item in a screen image displayed on the display apparatus 100 as an application selected by a user is executed and terminated on the display apparatus 100.

In one embodiment, the display apparatus 100 may provide a user interface including at least one item in a portion of a screen image displayed on the display apparatus 100 while an application selected by a user is being executed on the display apparatus 100.

In one embodiment, the display apparatus 100 may also provide a user interface including a plurality of items in response to a user input for selecting at least one item displayed on the display apparatus 100.

FIG. 5A is a diagram illustrating an example of initial screen images displayed as a display apparatus is turned ON. Referring to FIG. 5A, the display apparatus 100 may provide a user interface 512 including a plurality of items corresponding to a plurality of applications, respectively. The reference numeral 500-1 of FIG. 5A indicates the display apparatus 100 that is turned OFF. When an input for turning ON the display apparatus 100, which is turned OFF as indicated by the reference numeral 500-1, is received, the display apparatus 100 may provide the user interface 512 including at least one item in an initial screen image 510 as indicated by the reference numeral 500-2 in FIG. 5A.

FIG. 5B is a diagram illustrating an example that the display apparatus 100 displays a user interface including a plurality of items in response to a user input for selecting at least one item displayed on the display apparatus 100.

Referring to FIG. 5B, as indicated by the reference numeral 500-3, a user interface 520 including a plurality of items is displayed on the display apparatus 100, like the initial screen image 510 illustrated in FIG. 5A.

Each of a plurality of displayed items may correspond to at least one application. For example, an item may correspond to one application. Therefore, when a user input for selecting the corresponding item is received, the display apparatus 100 may execute the application corresponding to the item. For example, an item may correspond to a plurality of applications. Therefore, when a user input for selecting the corresponding item is received, the display apparatus 100 may display a user interface including a plurality of items corresponding to the plurality of application corresponding to the selected item.

Referring to the reference numeral 500-3 of FIG. 5B, an item 524 among a plurality of items displayed on the display apparatus 100 may indicate a group of a plurality of applications. For example, when a user selects the item 524 in the user interface 520 indicated by the reference numeral 500-3 of FIG. 5B, the display apparatus 100 may execute an application corresponding to the selected item 524 in response to the user's input. Furthermore, the application corresponding to the item 524 may be a DRM-removed application. The display apparatus 100 may display an execution screen image 530 of the application corresponding to the item 524 as indicated by the reference numeral 500-4 of FIG. 5B. The display apparatus 100 may provide a user interface 532 including a plurality of items corresponding to a plurality of applications included in the group of a plurality of applications indicated by the selected item 524.

For example, the item 524 provided in the user interface 520 shown in the left portion of FIG. 5B may correspond to an application “APPs.” The display apparatus 100 may display the execution screen image 530 of the application “APPs.” The display apparatus 100 may display the execution screen image 530 showing a group of a plurality of applications. The group of the plurality of applications may include applications that may be executed on the display apparatus 100 or applications that may be downloaded from the display apparatus 100. The display apparatus 100 may provide a user interface 532 including a plurality of items 534 including names and descriptions of the respective applications shown in the execution screen image 530 of the application “APPs.” The items 534 included in the user interface 532 may include other items for executing an application on the display apparatus 100 or downloading an application from the display apparatus 100.

In operation S120, the display apparatus 100 may remove DRM of at least one of a plurality of applications (operation S120).

In detail, the display apparatus 100 may remove DRM of at least one application corresponding to items included in a user interface before a user input for selecting one of a plurality of items included in the user interface is received.

Referring to the reference numeral 500-2 of FIG. 5A, the display apparatus 100 may remove DRM based on an input for turning the display apparatus 100 ON. Furthermore, the display apparatus 100 may remove DRM of a plurality of applications corresponding to items that may be displayed in the user interface 512 before a user input for selecting one of the plurality of items is received.

Referring to the reference numeral 500-4 of FIG. 5B, in response to a user input for selecting the item 524 provided in the user interface 520, the display apparatus 100 may remove DRM of a plurality of applications corresponding to the items included in the user interface 532.**

Referring to FIGS. 5A and 5B, the display apparatus 100 may remove DRM of some of applications corresponding to items included in the user interfaces 512 and 532. For example, the display apparatus 100 may remove DRM of applications included in a list stored in the storage 190. Furthermore, the display apparatus 100 may remove DRM of recently executed applications. In another example, the display apparatus 100 may remove DRM of frequently executed applications. In another example, the display apparatus 100 may remove DRM of applications provided by the manufacturer of the display apparatus 100.

In operation S130, the display apparatus 100 may execute an application corresponding to a selected item (operation S130).

In detail, based on a user input for selecting one of a plurality of items, the display apparatus 100 may execute a DRM-removed application corresponding to the selected item.

Unlike a method of removing DRM of an application corresponding to a selected item and executing the application after a user's selection is received, DRM of applications available to be selected by a user may be removed in the operation S120 in advance before the user selects an application. Therefore, a time period for the user to wait for DRM removal may be reduced.

For example, referring to 500-3 of FIG. 5B, the display apparatus 100 may execute a DRM-removed application corresponding to the item 524 in response to a user input for selecting the item 524. Referring to 500-4 of FIG. 5B, the display apparatus 100 may display an execution screen image 550 of the DRM-removed application. Referring to 500-4 of FIG. 5B, the display apparatus 100 may display the execution screen image 550 and remove DRM of some of applications corresponding to the items included in the user interface 532.

Referring to 500-5 of FIG. 5C, the display apparatus 100 may execute a DRM-removed application corresponding to an item 544 based on a user input. Referring to 500-6 of FIG. 5C, the display apparatus 100 may display the execution screen image 550 of the DRM-removed application.

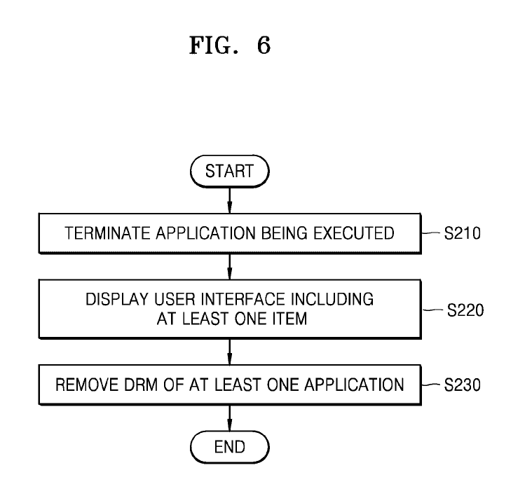

FIG. 6 is a flowchart illustrating an example method of operating the display apparatus 100 according to another example embodiment.

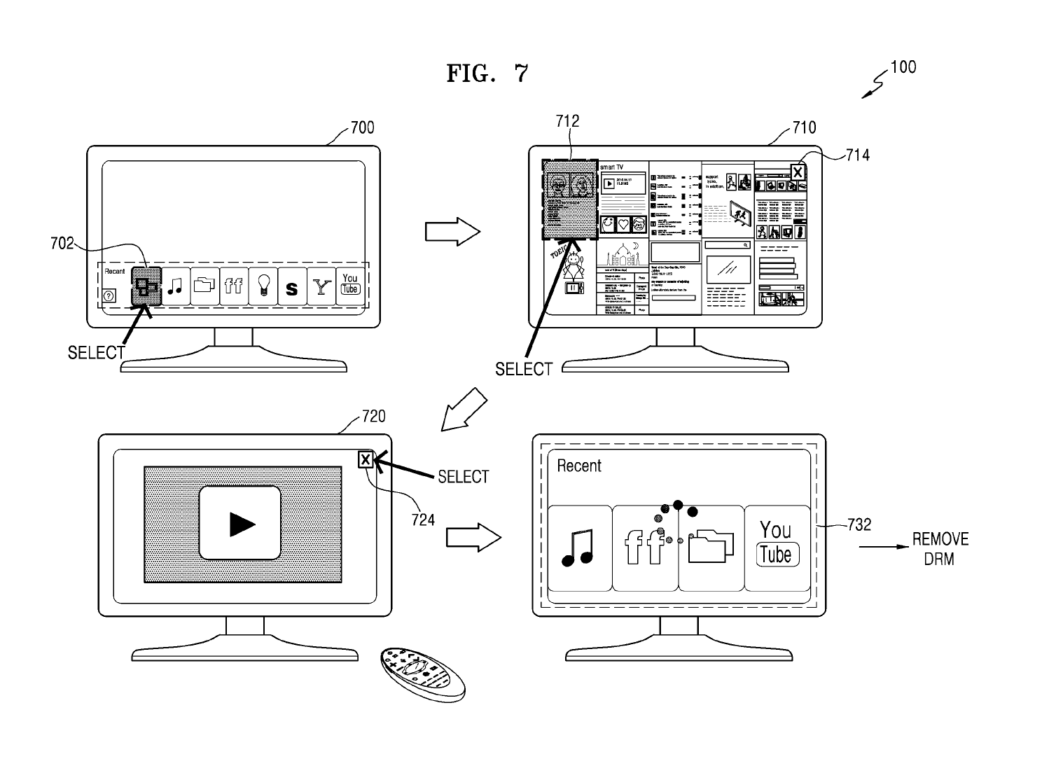

Hereinafter, the flowchart illustrated in FIG. 6 will be described in relation to the display apparatus 100 illustrated in FIG. 7.

In operation S210, the display apparatus 100 may terminate an application being executed (operation S210).

For example, the display apparatus 100 may terminate an application based on a user input. Furthermore, the display apparatus 100 may terminate an application being executed as the process of the application is terminated. For example, the display apparatus 100 may terminate an application at a time point at which content accessed in the application is terminated. Referring to FIG. 7, the display apparatus 100 may terminate an application based on a user input for selecting an end button 714 provided in an execution screen image 710 of FIG. 7. In detail, the execution screen image 710 of FIG. 7 may be the execution screen image 710 of an application corresponding to an item 702 of FIG. 7.

Furthermore, the display apparatus 100 may terminate an application based on a user input for selecting an end button 724 provided in an execution screen image 720 of FIG. 7. In detail, the execution screen image 720 of FIG. 7 may be the execution screen image 720 of an application corresponding to an item 712 of FIG. 7B.

In operation S220, the display apparatus 100 may display a user interface including at least one item (operation S220).

In detail, as an application is terminate in the operation S210, the display apparatus 100 may display a user interface including at least one item.

Referring to FIG. 7, as an application is terminate in the operation S210, the display apparatus 100 may display a user interface 732 including at least one item.

Meanwhile, the screen image including the user interface 732 described above with reference to FIG. 7 is merely an example. In other words, based on termination of an application, the display apparatus 100 may display the execution screen image 710 shown in FIG. 7 or an initial screen image 700 shown in FIG. 7. furthermore, based on termination of an application, the display apparatus 100 may display an execution screen image of another application that was executed just before the terminated application was executed.

In operation S230, the display apparatus 100 may remove DRM of at least one application (operation S230).

In detail, the display apparatus 100 may remove DRM of at least one application corresponding to at least one item included in the user interface displayed in the operation S220.

Referring to FIG. 7, the display apparatus 100 may remove DRM of at least one application corresponding to at least one item included in the user interface 732.

The display apparatus 100 may remove DRM of all applications corresponding to items included in the user interface 732. Furthermore, the display apparatus 100 may remove DRM of applications meeting pre-set criteria among applications corresponding to items included in the user interface 732.

For example, the display apparatus 100 may remove DRM of applications included in a list stored in the storage 190. Furthermore, the display apparatus 100 may remove DRM of recently executed applications. In another example, the display apparatus 100 may remove DRM of frequently executed applications. In another example, the display apparatus 100 may remove DRM of applications provided by the manufacturer of the display apparatus 100.

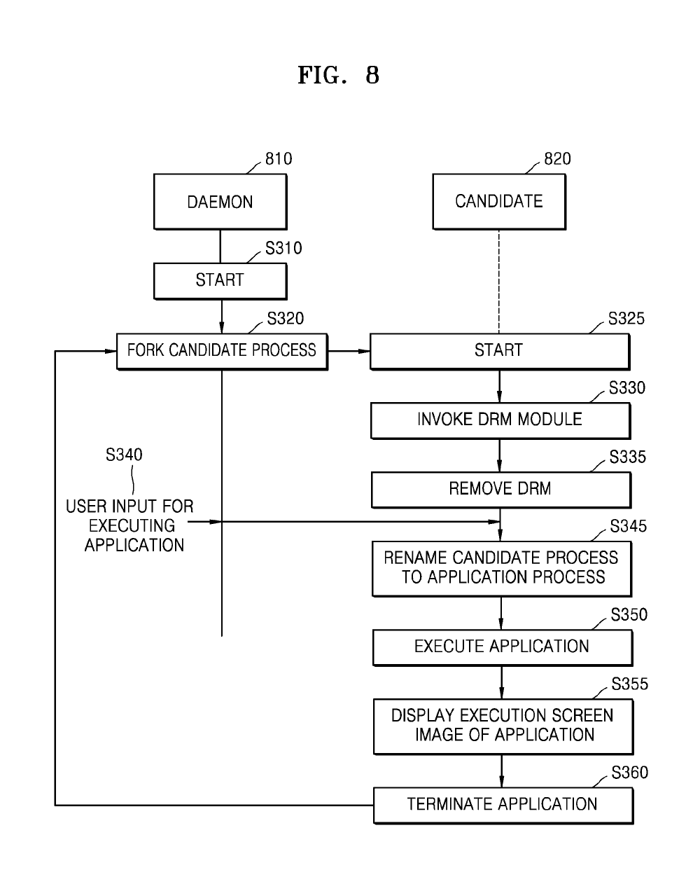

FIG. 8 is a flowchart illustrating an example method by which the display apparatus 100 removes DRM of an application using a daemon.

In one embodiment, the display apparatus 100 may execute a daemon 810 stored in the storage 190.

In operation S310, the daemon 810 may be initiated when the display apparatus 100 is turned ON (operation S310).

For example, when an OS stored in the display apparatus 100 is initiated, the daemon 810 may be initiated. The display apparatus 100 may control the daemon 810 to operate in the background while the display apparatus 100 is ON. Here, the OS stored in the display apparatus 100 may include Android, Tizen, webOS, Firefox OS, Windows, Windows Mobile, etc. for example, when the OS stored in the display apparatus 100 is Tizen, the daemon 810 may include a launch pad.

In operation S320, the daemon 810 may fork a candidate process 820 (operation S320).

In detail, the display apparatus 100 may control the daemon 810 to fork the candidate process 820. Here, forking a process includes generation of the process. In other words, the daemon 810 may generate the candidate process 820 by forking the candidate process 820. Here, the daemon 810 may be a parent process, whereas the candidate process 820 may be a child process of the daemon 810.

In operation S325, the candidate process 820 forked by the daemon 810 may be executed (operation S325). The initiation of the candidate process 820 may also be referred to as generation of the candidate process 820. Here, the display apparatus 100 may control the daemon 810 to run in the background.

In operation S330, the candidate process 820 may invoke a DRM module for remove DRM (operation S330).

In detail, the display apparatus 100 may control the candidate process 820 to invoke a DRM module stored in the storage 190. Furthermore, the display apparatus 100 may control the candidate process 820 to load a DRM module for removing DRM to a memory. For example, the memory may include a share memory and may include the RAM 181 shown in FIG. 3.

In operation S335, the candidate process 820 may remove DRM by using the DRM module loaded to the memory (operation S335).

Here, the display apparatus 100 may allocate a memory space for removing DRM of at least one application. An application to be DRM-removed may correspond to at least one item displayed in a user interface of the display apparatus 100. For example, an application to be DRM-removed may include at least one application corresponding to at least one item that may be displayed in a user interface based on an input for turning ON the display apparatus 100.

In operation S340, the daemon 810 and the candidate process 820 may receive a user input for executing an application (operation S340).

For example, the user input may include an input for selecting one of a plurality of items displayed in a user interface displayed on the display apparatus 100. A user may select an item by using the control apparatus 200 (refer to FIG. 1). The selected item may correspond to an DRM-removed application.

In operation S345, the daemon 810 may rename the candidate process 820 to the process of an application based on a user input for executing the application.

In detail, based on a user input for executing an application, the display apparatus 100 may transmit a command for executing the application to an application utility library (AUL), which is a daemon process of the display apparatus 100. The AUL may control execution and termination of an application. For example, the AUL may transmit a command for executing an application to the candidate process 820 being executed. Based on the command transmitted by the AUL, the candidate process 820 may change the name of the candidate process 820 to that of an application to be executed by using a prctl function.

The candidate process 820 with the name changed to that of the application to be executed may invoke data related to the application from the library of the application. In one embodiment, the candidate process 820 may be a candidate process generated by a launch pad of Tizen. The candidate process 820 may invoke application-related data stored in so-library by using a function dlopen( ). Here, the candidate process 820 may invoke an DRM-removed application, and it may be understood that the candidate process 820 is renamed to the process of an application to be executed.

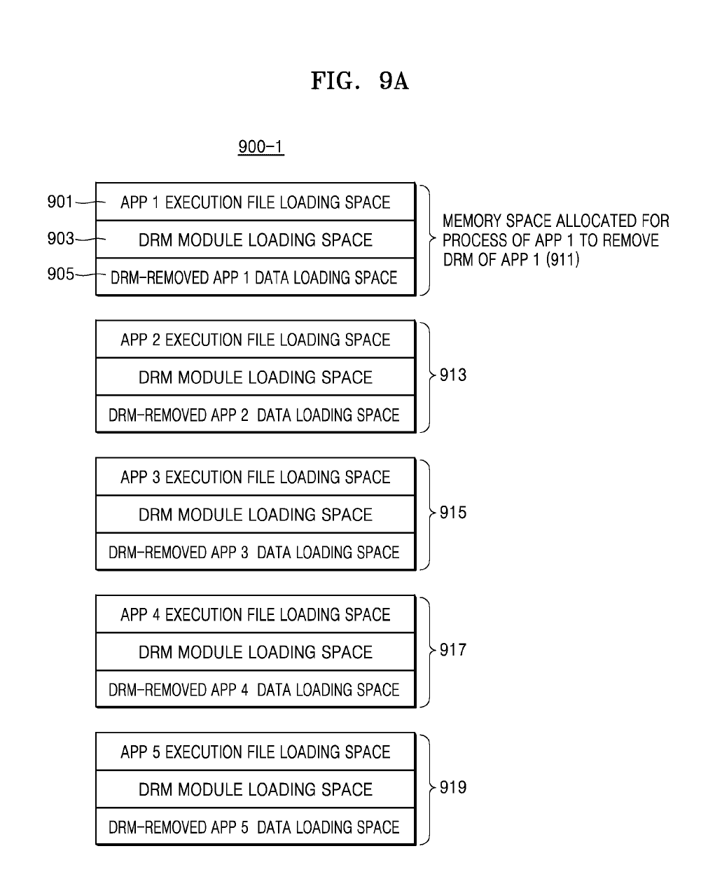

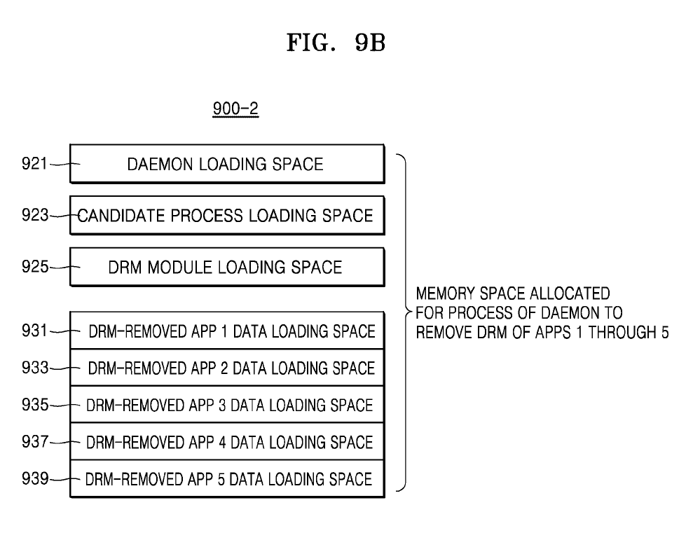

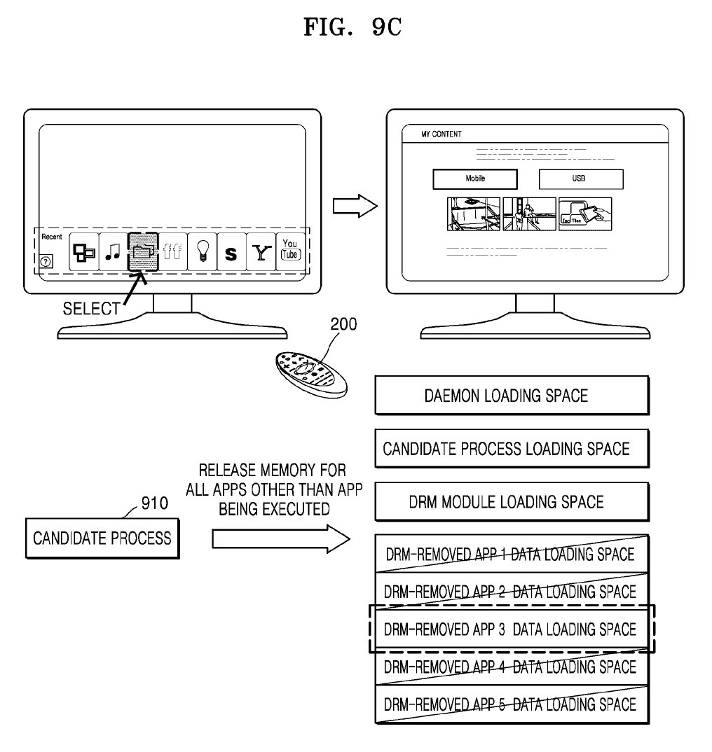

In order to remove DRM of the application invoked by using the function dlopen( ), the display apparatus 100 may release all memory spaces allocated in the operation S335 with regard to applications other than the invoked application, while not releasing the memory space related to the invoked application. Detailed description thereof will be given below with reference to FIG. 9.

In operation S350, the display apparatus 100 may execute an application (operation S350). In detail, the display apparatus 100 may invoke main( ) and execute the process of a DRM-removed application.

In operation S355, the display apparatus 100 may display an execution screen image of an application (operation S355).

For example, the display apparatus 100 may display an execution screen image of an application as those shown in 500-4 of FIG. 5B and 500-6 of FIG. 5C.

In operation S360, an application being executed on the display apparatus 100 may be terminated (operation S360).

The display apparatus 100 may terminate an application based on a user input for terminating the application. Furthermore, the display apparatus 100 may terminate an application at a time point at which reproduction of content accessed on the application is terminated.

In one embodiment, when an application being executed is terminated, the display apparatus 100 may control a daemon to execute a candidate process again. In detail, the display apparatus 100 may control the daemon 810 to fork the candidate process 820 (operation S320) again. When the daemon 810 forks the candidate process 820, the display apparatus 100 may control the candidate process 820 to be executed again (operation S325). Next, the display apparatus 100 may perform the operation S330 and the operation S335 for DRM removal.

Here, an application DRM-removed in the operation S330 and the operation S335 may include at least one application corresponding to at least one item that may be displayed in a user interface based on termination of the application.

FIGS. 9A through 9C are diagrams illustrating an example in which the display apparatus 100 allocates a memory space for removing DRM.

Referring to FIGS. 9A and 9B, the display apparatus 100 may allocate a memory space for removing DRM of a plurality of applications. In one embodiment, when the display apparatus 100 removes DRM of a plurality of applications at once before a user input is received, a large memory space may be necessary for the DRM removal. Therefore, in one embodiment, when the display apparatus 100 removes DRM of a plurality of applications at once, it is necessary to use a daemon as described above with reference to FIG. 8 to save a memory space.

In detail, FIGS. 9A and 9B show that the display apparatus 100 allocates memory spaces for removing DRM of an application 1, an application 2, an application 3, an application 4, and an application 5 in one embodiment.

FIG. 9A shows that the display apparatus 100 executes a plurality of application processes and removes DRM of each application. FIG. 9B shows that DRM of each of a plurality of applications is removed by using a daemon.

Hereinafter, memory spaces allocated when the display apparatus 100 does not include a daemon will be compared to memory spaces allocated when the display apparatus 100 includes a daemon, with reference to FIGS. 9A and 9B.

FIG. 9A shows some of memory spaces when the display apparatus 100 removes DRM of an application after the process of the application is executed.

Referring to 900-1 of FIG. 9A, when the display apparatus 100 removes DRM of an application 1, the display apparatus 100 may need an application execution file loading space 901, a DRM module loading space 903, and a data loading space 905 for the DRM-removed application 1 in order to remove DRM.

Similarly, referring to 900-1 of FIG. 9A, when the display apparatus 100 removes DRM of each of applications 2 through 5, the display apparatus 100 may allocate memory spaces 913, 915, 917, and 919, each of which has a same size as a memory space 907 allocated for removing DRM of the application 1.

FIG. 9B shows some of memory spaces allocated when a daemon invokes a candidate process and removes DRM of an application before the process of the application is executed.

For example, the display apparatus 100 may remove DRM of each of an application 1, an application 2, an application 3, an application 4, and an application 5 in advance before a user input for executing the application 3 is received.

Referring to FIG. 9B, when the display apparatus 100 removes DRM of at least one application, the display apparatus 100 may need a daemon loading space 921, a candidate process loading space 923, a DRM module loading space 925, and data loading spaces 931, 933, 935, 937, and 939 for at least one DRM-removed application.

In the embodiment shown in FIG. 9B, it is not necessary for the display apparatus 100 to separately load an executable file and a DRM module of each of the applications 1 through 5 for removing DRM of each of the applications 1 through 5, thereby saving a memory space.

In other words, comparing the example embodiment shown in FIG. 9B in which the memory spaces 931, 933, 935, 937, and 939 for removing DRM are allocated by a candidate process executed by a daemon to the example embodiment shown in FIG. 9A in which application processes are executed and memory spaces for removing DRM are allocated by the respective application processes, the amount of required memory may be reduced for removing.

Referring to FIG. 9C, a candidate process 910 of the display apparatus 100 may release a memory space regarding an unexecuted application among memory spaces allocated in FIG. 9B with regard to a plurality of applications.

For example, the display apparatus 100 may receive a user input for selecting one of a plurality of items displayed in a user interface. An item selected based on the user input may correspond to a DRM-removed application 3.

For example, the item selected based on the user input may correspond to the application 3. The candidate process 910 may fork the application 3 based on the user input. When the application is forked, the display apparatus 100 may execute the DRM-removed application 3. Here, the candidate process 910 may release all of memory spaces regarding applications other than the forked application among memory spaces allocated for DRM removal. In other words, except a memory space allocated for removing DRM of the application 3, the candidate process 910 may release memory spaces allocated with regard to the application 1, the application 2, the application 4, and the application 5.

In the embodiment shown in FIG. 9C, the display apparatus 100 may release all of memory spaces regarding applications other than a forked application among memory spaces allocated for DRM removal, based on a user input for selecting one of a plurality of items. Therefore, the display apparatus 100 may utilize the released memory spaces for other processes.

The above-described embodiments of the disclosure may be implemented as programmable instructions executable by a variety of computer components and stored in a computer readable recording medium. The computer readable recording medium may include program instructions, a data file, a data structure, or any combination thereof. The program instructions stored in the computer readable recording medium may be designed and configured specifically for the disclosure or can be publicly known and available to those skilled in the field of software. Examples of the computer readable recording medium include a hardware device specially configured to store and perform program instructions, for example, a magnetic medium, such as a hard disk, a floppy disk, and a magnetic tape, an optical recording medium, such as a CD-ROM, a DVD, and the like, a magneto-optical medium, such as a floptical disc, a ROM, a RAM, a flash memory, and the like. Examples of the program instructions include machine codes made by, for example, a compiler, as well as high-level language codes executable by a computer using an interpreter.

According to a display apparatus and a display method according to example embodiments of the disclosure, an efficiency of removing DRM of an application may be improved, and thus user satisfaction may be increased.

In detail, as a display apparatus performs DRM removal before a user input for executing an application is received, the display apparatus may reduce time period for a user to wait for DRM removal.

Furthermore, when memory spaces for removing DRM are allocated by a daemon in a display apparatus before an application is executed, a memory space may be saved as compared to a case where memory spaces for removing DRM are allocated by application processes after the application processes are executed.

It should be understood that the various example embodiments described herein should be considered in a descriptive sense only and not for purposes of limitation. Descriptions of features or aspects within each embodiment should typically be considered as available for other similar features or aspects in other embodiments.

While one or more example embodiments have been described with reference to the figures, it will be understood by those of ordinary skill in the art that various changes in form and details may be made therein without departing from the spirit and scope as defined by the following claims.

What is claimed is:

1. A display apparatus comprising:
a display configured to display a user interface comprising at least one item corresponding to at least one application, wherein, based on an input for selecting the item, an application corresponding to the selected item is executed; and
a controller configured to remove digital rights management (DRM) of the at least one application corresponding to the at least one item before the input for selecting one of the at least one displayed item is received.

2. The display apparatus of claim 1, wherein the controller is configured to execute the DRM-removed application in response to the input.

3. The display apparatus of claim 1, wherein the controller is configured to remove DRM of the at least one application corresponding to the at least one item to be displayed in the user interface based on an input for turning ON the display apparatus.

4. The display apparatus of claim 1, wherein the controller is configured to remove DRM of the at least one application corresponding to the at least one item to be displayed in the user interface as an application that is being executed based on the input is terminated.

5. The display apparatus of claim 1, wherein the controller is configured to remove DRM of an application using a daemon.

6. The display apparatus of claim 5, wherein the daemon is configured to execute a candidate process, and
the candidate process is configured to load a DRM module for removing DRM to a memory.

7. The display apparatus of claim 6, wherein the candidate process is renamed to the process of the application based on the input.

8. A display method comprising:
displaying a user interface comprising at least one item corresponding to at least one application, wherein, based on an input for selecting the item, an application corresponding to the selected item is executed; and
removing digital rights management (DRM) of the at least one application corresponding the at least one item before the input for selecting one of the at least one displayed item is received.

9. The method of claim 8, wherein the DRM-removed application is executed in response to the input.

10. The method of claim 8, wherein the removing of the DRM comprises removing DRM of the at least one application corresponding to the at least one item to be displayed in the user interface based on an input for turning ON a display apparatus.

11. The method of claim 8, wherein the removing of the DRM comprises removing DRM of the at least one application corresponding to the at least one item to be displayed in the user interface as an application that is being executed based on the input is terminated.

12. The method of claim 9, wherein the removing of the DRM comprises removing DRM of an application using a daemon.

13. The method of claim 12, wherein the removing of the DRM using the daemon comprises:
executing a candidate process via the daemon; and
loading a DRM module for removing DRM to a memory via the candidate process.

14. The method of claim 13, wherein the removing of the DRM using the daemon further comprises renaming the candidate process to the process of the application based on the input.

15. A non-transitory computer readable recording medium having recorded thereon a computer program for implementing the method of claim 8.
